(19) United States
(12) Patent Application Publication
(10) Pub. No.: US 2021/0173706 A1
(43) Pub. Date: Jun. 10, 2021

(54) COGNITIVE SCHEDULING ENGINE

(71) Applicant: INTERNATIONAL BUSINESS MACHINES CORPORATION, Armonk, NY (US)

(72) Inventors: Kim Poh Wong, Singapore (SG); Rakesh Ganjoo, Bedminster, NJ (US)

(21) Appl. No.: 16/703,082

(22) Filed: Dec. 4, 2019

(51) Int. Cl. G06F 9/48; G06N 7/00

(52) U.S. Cl. CPC G06F 9/4887; G06N 7/005

(57) ABSTRACT

Systems and methods are provided for cognitive scheduling. A computer-implemented cognitive scheduling method includes receiving a plurality of computer executable tasks. The cognitive scheduling method also determines environmental parameters for executing each of the plurality of computer executable tasks. Additionally, the cognitive scheduling method generates a risk assessment for the plurality of computer executable tasks based on the environmental parameters of the respective computer executable tasks compared against a set of annotation criteria. A time slot in a scheduling list is assigning to each of the plurality of computer executable tasks based on the risk assessment. Based on the scheduling list, each of the plurality of computer executable tasks is executed in chronological order.

### BACKGROUND

The present disclosure generally relates to automated task scheduling in computer systems, and more particularly to a cognitive scheduling engine in a distributed computing environment.

In a distributed environment, in which a single physical server hosts multiple virtual servers, virtual servers host multiple applications and subsystems. Data center environments are shifting towards containerization and focusing more on operating-system-level virtualization. Tasks executed in virtual servers of a distributed environment are generally isolated within the respective virtual server such that a task executing in one virtual server does not interfere with the proper execution of another task on another virtual server. However, some tasks, such as, for example, system maintenance, data backup, etc. can impact more than one virtual server hosted by the physical server.

### SUMMARY

In accordance with an embodiment of the present disclosure, a computer-implemented cognitive scheduling method is provided. The computer-implemented cognitive scheduling method includes receiving a plurality of computer executable tasks. The cognitive scheduling method also determines environmental parameters for executing each of the plurality of computer executable tasks. Additionally, the cognitive scheduling method generates a risk assessment for the plurality of computer executable tasks based on the environmental parameters of the respective computer executable tasks compared against a set of annotation criteria. The risk assessment includes an evaluation of the probability that high priority scheduled tasks can be executed and successfully completed within a set of constraints provided by the annotation criteria under which the individual computer-implemented tasks are to be executed. A time slot in a scheduling list is assigning to each of the plurality of computer executable tasks based on the risk assessment. Based on the scheduling list, each of the plurality of computer executable tasks is executed in chronological order.

In accordance with another embodiment, a cognitive scheduling system is provided. The cognitive scheduling system includes a network interface configured to receive a plurality of computer executable tasks over a network; a storage device configured to store the plurality of tasks, a set of annotation criteria and a scheduling list; a processor. The processor is configured to determine environmental parameters for executing each of the plurality of tasks stored in the storage device. Additionally, a risk assessment for the plurality of tasks is generated based on the environmental parameters of the respective tasks compared against the set of annotation criteria. The risk assessment includes an evaluation of the probability that high priority scheduled tasks can be executed and successfully completed within a set of constraints provided by the annotation criteria under which the individual computer-implemented tasks are to be executed. A time slot in the scheduling list is assigned to each of the plurality of tasks based on the risk assessment. Based on the scheduling list, each of the plurality of tasks is executed in chronological order.

In yet another embodiment, a non-transitory computer readable storage medium is provided that includes a computer-readable program implementing a cognitive scheduling method. The computer-readable program, when executed on a computer, causes the computer to perform the steps of: receiving a plurality of computer executable tasks; determining environmental parameters for executing each of the plurality of tasks; generating a risk assessment for the plurality of tasks based on the environmental parameters of the respective tasks compared against a set of annotation criteria. The risk assessment includes an evaluation of the probability that high priority scheduled tasks can be executed and successfully completed within a set of constraints provided by the annotation criteria under which the individual computer-implemented tasks are to be executed. Additionally, the computer-readable program, when executed on a computer, causes the computer to perform the steps of: assigning a time slot in a scheduling list to each of the plurality of tasks based on the risk assessment; and executing each of the plurality of tasks in chronological order based on the scheduling list.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block representation of a physical server for implementing a cognitive scheduling engine, in accordance with an embodiment of the present disclosure.

FIG. 2 is a block representation of a cognitive scheduling engine, in accordance with an embodiment of the present disclosure.

FIG. 3 is a flow diagram showing a method implementing the cognitive scheduling engine, in accordance with an embodiment of the present disclosure.

FIG. 4 is a flow diagram showing a method implementing the cognitive scheduling engine, in accordance with an embodiment of the present disclosure.

FIG. 5 is a flow diagram showing a method implementing the cognitive scheduling engine, in accordance with an embodiment of the present disclosure.

FIG. 6 is a block representation of a system incorporating a cognitive scheduling engine into overall services within multi-cloud environment, covering services and access software defined control, and software defined environment within IT cloud and other clouds (e.g. OpenStack, Public Cloud), in accordance with an embodiment of the present disclosure.

FIG. 7 is a block diagram showing an illustrative cloud computing environment having one or more cloud computing nodes with which local computing devices used by cloud consumers communicate in accordance with one embodiment.

FIG. 8 is a block diagram showing a set of functional abstraction layers provided by a cloud computing environment in accordance with one embodiment.

### DETAILED DESCRIPTION

Reference in the specification to “one embodiment” or “an embodiment” of the present disclosure, as well as other variations thereof, means that a particular feature, structure, characteristic, and so forth described in connection with the embodiment is included in at least one embodiment of the present disclosure. Thus, the appearances of the phrase “in one embodiment” or “in an embodiment”, as well any other variations, appearing in various places throughout the specification are not necessarily all referring to the same embodiment.

A task, within the context of embodiments of the present disclosure, is an instruction for a computing device to execute one or more programs, applications, services, functions and/or operations. In some embodiments, tasks can be executed, e.g., run, immediately upon receipt by the computing device, such as a server or desktop computer. In other embodiments, tasks can be scheduled to run at a later, predefined date and time. Moreover, when tasks are scheduled, the task can be scheduled to run at set intervals, for example, every day, once per week, monthly, etc. Examples of scheduled tasks include nightly incremental data backups and monthly full backups, weekly application updates, hourly virus scans, etc. Often tasks, especially computer maintenance related tasks, are scheduled to execute unattended, and at hours of the day when computer workload is at a minimum. Servers, data centers operation components, and virtualization servers can have numerous tasks scheduled to execute each night.

When scheduling tasks, in accordance with embodiments of the present disclosure, the task can be evaluated to identify resources that will need to be allocated to the task in order for the task to execute properly. Additionally, conflicts can be identified between the task and any other scheduled task. Also, in some embodiments, the task can be compared with other scheduled tasks to identify duplication, namely duplicate tasks. In some embodiments, a task's dependency on other applications or tasks is also evaluated. In some other embodiments, the tasks can be evaluated to determine which tasks can be executed simultaneously and which cannot based on the individual task resource requirements, task dependencies, etc., for example.

Moreover, during execution of the task, embodiments can log any conflicts that occur—noting the conflicting task and any other useful troubleshooting information. In addition to any conflicts, embodiments can also generate an error log that collects any errors, warnings or comments issued by the task during execution. The conflict log and error log can be evaluated by embodiments of the present disclosure, to provide conflict resolution and error resolution by identifying problems with a schedule, and adjust the schedule as necessary in order to correct the issues or notify a user of an issue that is not correctable by way of scheduling adjustments.

Embodiments of the present disclosure provide a cognitive scheduling engine that analyzes tasks that are scheduled to execute automatically to identify system requirements and conflicts with other tasks being scheduled. The cognitive scheduling engine, using the identified requirements and conflicts of each task, schedules the automated tasks in an order that reduces conflicts and increase system processing efficiency. For example, some embodiments can be configured to break down the task, e.g., analyze the requirements of the task, validate the algorithm to determine the set of rules (such as, for example, specific processes, upstream jobs, downstream jobs, and concurrent job to be scheduled), provide conflicts checksum management, rearrange the scheduled tasks as necessary to satisfy predefined operating constraints, and resolve conflicts and errors that arise during execution of the scheduled tasks. The conflicts checksum is used to determine whether a problem related to a particular file for processing is due to connection or resource problems.

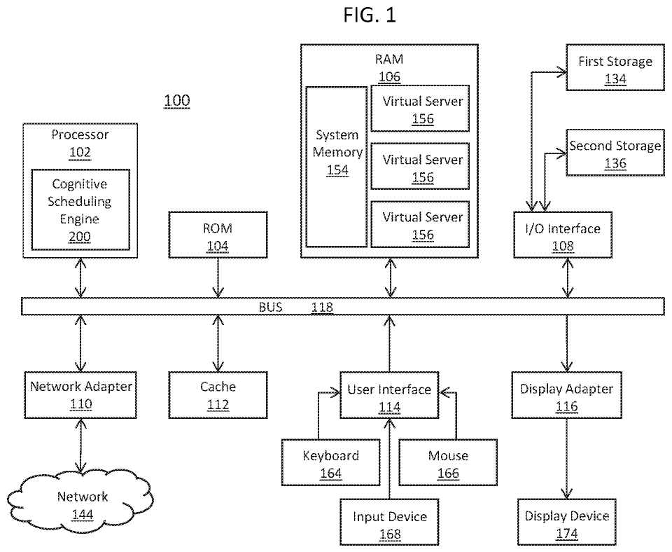

FIG. 1 illustrates components of a physical server 100 of a distributed computing environment in accordance with embodiments of the present disclosure. The physical server 100 includes a system bus 118 electrically coupled to a processor device 102, memory devices, such as, for example, read-only memory (ROM) 104, random-access memory (RAM) 106, and cache memory 112, storage devices (e.g., first storage 134, second storage 136) via an input/output (I/O) interface 108, network adapter 110, user interface 114 and a display device 174 coupled via a display adapter 116. The physical server 100 can be connected to a network 144 such as, for example, a local area network (LAN), wide area network (WAN) or the Internet by way of the network adapter. The user interface 114 allows various user interface devices, such as, for example, a keyboard 164, a mouse 166, and other input devices 168, to be coupled to the physical server 100, allowing a system user to interact with the physical server 100.

The physical server includes several virtual servers 156 which are implemented by the processor 102 in a portion of memory (for example RAM 106) allocated for the purpose. Separately, a portion of RAM 106 is also allocated as system memory 154, which is used by the processor 102 for implementing various system (e.g., physical server 100) level applications, operations, services and tasks.

In some embodiments, storage devices (e.g., first storage 134, second storage 136) may be configured to provide virtual memory, which is perceived by the processor as additional RAM. In such embodiments, the virtual servers can be implemented in RAM 106, virtual memory, or in both RAM 106 and virtual memory. The storage devices 134 and 136 can be implemented as solid-state devices, such as, for example flash drives, secure digital (SD) cards, multimedia cards (MMC), hard drives, optical drives, etc.

In embodiments, the processor 102 can be configured, by way of computer-readable programs, for example, to implement a cognitive scheduling engine 200. In other embodiments, the cognitive scheduling engine 200 can be implemented in hardware, such as by an FPGA (not shown) in which the gate arrays have been configured to implement the cognitive scheduling method described in detail below. In still other embodiments, the cognitive scheduling engine can be implemented by a plurality of processors 102 in a distributed manner, such that the various functions of the cognitive scheduling engine 200 described below are executed by separate processors. In still other embodiments, the cognitive scheduling engine 200 can be implemented in a combination of hardware and software that can, for example, include processors 102 and FPGA devices.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present disclosure provided herein.

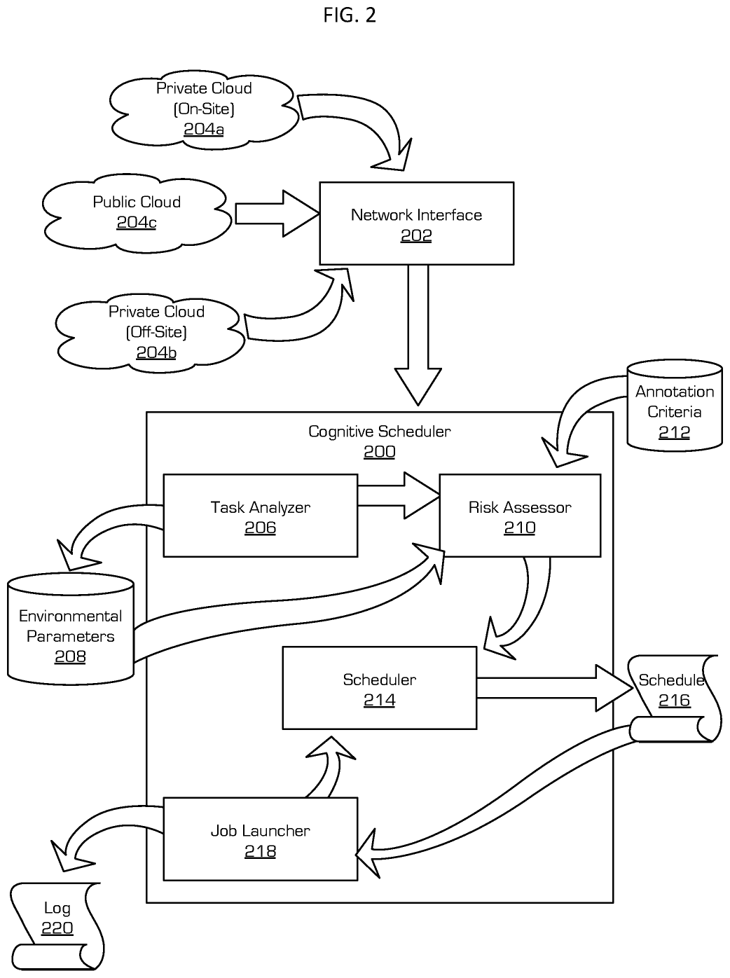

Turning to FIG. 2, a cognitive scheduling engine 200 is shown. The cognitive scheduling engine 200 can be implemented by computer-executable instructions, embodied, for example, in one or more programs, executed by a processor, such as, for example, the processor 102 shown in FIG. 1.

In some embodiments, the cognitive scheduling engine 200 is implemented on the physical server 100 that is also implementing one or more virtual servers 156. In other embodiments, the cognitive scheduling engine 200 is implemented on a separate computer system having similar components as the physical server 100. However, the separate computer system may not have virtual servers 156 implemented thereon. The physical server 100 and the separate computer system can be in communication by way of a shared network 144. For simplicity, the present disclosure will be described herein below with reference to the cognitive scheduling engine 200 being implemented by the physical server 100.

In an embodiment, the cognitive scheduling engine 200 receives a plurality of computer executable tasks from various sources. For example, the cognitive scheduling engine 200 can receive tasks, by way of a network interface 202, for example, network adapter 110 shown in FIG. 1, from an on-site private cloud network 204a (e.g., local area network), an off-site private cloud network 204c (e.g., wide area network), and/or a public cloud network 204b (e.g., the Internet). Additionally, tasks can be embodied in a local storage device, such as, for example, first storage 134 or second storage 136 of the physical server 100. Where the tasks are embodied locally, the cognitive scheduling engine 200 receives the tasks from the storage device by way of the system bus 118. In an embodiment, the cognitive scheduling engine 200 can identify tasks for scheduling by executing a query on the physical server 100 (see: FIG. 1), execution tools, dynamic automation, backup manager tools, workload schedulers, configuration management database (CMDB) tools, information technology service management (ITSM) tools, etc.

Additionally, the cognitive scheduling engine 200 can be configured to utilize the various data inputs to build the application affinities between the various functions to ensure optimized job execution and identification of the resources required, such as, for example, web, middleware, and database. Further, the cognitive scheduling engine 200 can be configured to utilize software-defined networking (SDN) to build software firewalls and micro-segmentation instances. The SDN ensures that access control is being managed within the segment. Moreover, the cognitive scheduling engine 200 can be configured to utilize software and human intervention to determine, and prevent, the spread of unwanted code installation, such as, for example, by including jobs to be scheduled and are related to virus/malware/source code scan.

Additionally, the cognitive scheduling engine 200, through operation of the processor 102 functioning as a task analyzer 206, for example, determines environmental parameters needed for properly executing each of the plurality of tasks. The environmental parameters 208 can be stored in, for example, a database embodied on a storage device, such as, for example, the first storage 134 and/or the second storage 136 of the physical server 100. Alternative data structures can be used to store the environmental parameters 208 without departing from the present disclosure. The environmental parameters 208 can be stored in a manner that maintains their association with their respective task. In some embodiments, the environmental parameters 208 can include computational requirements of a task, such as, for example, memory, processor threads, and network requirements, dependency on external scripts and results from other tasks, and/or processing time.

Also, a risk assessor 210, implemented by the cognitive scheduling engine 200 through operation of the processor 102, generates a risk assessment for the plurality of tasks based on the environmental parameters 208 of the respective tasks compared against a set of annotation criteria 212. The risk assessment can include an evaluation of the probability that the high priority tasks can be executed and successfully completed within the constraints provided by the set of annotation criteria. The annotation criteria 212 can include parameters associated with constraints under which the tasks are to be executed. For example, one annotation criteria 212 can be a completion deadline such as, for example, where all tasks need to successfully complete execution by a certain time each day in order to satisfy regulatory compliance. Another annotation criteria 212 can include system parameters, such as, for example, total available system memory 154 (see: FIG. 1), processor capabilities, installed applications available as dependencies for a task, network bandwidth, etc.

In an embodiment, the risk assessor assigns values to a list attributes (e.g., parameters and criteria associated with executing the task); and based on the total value, a hexadecimal value is generated from which a unique checksum is calculated for each task.

The risk assessor 210 retrieves environmental parameters 208 associated with a respective task whose risk is being assessed. Additionally, the risk assessor 210 retrieves annotation criteria 212 stored in, for example, a database embodied on a storage device, such as, for example, the first storage 134 and/or the second storage 136 of the physical server 100.

The risk assessor 210 applies a Bayesian algorithm (e.g., an implementation of Bayes' Theorem), with the environmental parameters 208 and the annotation criteria 212 as inputs, to calculate the probability of an outcome given the value of some variable, that is, to calculate the probability of a hypothesis (h), e.g. whether a task can be completed within the constraints of the annotation criteria, being true, given prior knowledge (d), i.e., the environmental parameters of the task based on identified dependencies within the operating environment. The Bayesian algorithm is configured to ensure that the most critical functions (e.g., tasks) are at the lowest risk possible for application downtime from unwanted code interruption or lack of system resources. An example of a Bayesian algorithm used in some embodiments is:

$${P}_{( h \vert d )} = \frac{{P}_{( d \vert h )} \times {P}_{( h )}}{{P}_{( d )}} \qquad Eq . 1$$

Where: P_{(h|d)} is a posterior probability, e.g., a probability of hypothesis h being true, given the data, from environmental parameters and annotation criteria d; P_{(d|h)} is a likelihood, e.g., a probability of data d given that the hypothesis h is true; P₍ₕ₎ is a class prior probability, e.g., a probability of hypothesis h being true irrespective of the data; P_{(d)} is a predictor prior probability, e.g., a probability of the data (irrespective of the hypothesis); and

P_{(h|D)}=P_{(d}_{₁}^{|h)}×P_{(d}_{₂}_{|h)}× . . . ×P_{(d}_{ₙ}_{|h)}×P₍ₕ₎ Eq. 2

Where: P_{(h|D)} is the posterior probability of a class (h, target) given a predictor (D, attributes); P₍ₕ₎ is the prior probability of the class; P_{(D|h)} is the likelihood, which is the probability of the predictor given the class; and P_{(D)} is the prior probability of the predictor.

Based on the results of the risk assessor 210, the tasks can be organized in a scheduling list 216 chronologically according to the task execution priority by a scheduler 214 of the cognitive scheduling engine 200 by way of instruction code and operation of the processor 102. Thus, the scheduler 214 assigns a time slot in the scheduling list 216 to each of the plurality of tasks based on the risk assessment. The scheduling list 216 can be implemented as a database stored in, for example, the first storage 134 and/or the second storage 136 of the physical server 100. The scheduling list 216 database can include, for each task to be executed, the task name (or other identifier), task location (e.g., path or uniform resource identifier to the task), execution time slot. Additionally, the database entry for each task in the scheduling list can include information regarding dependencies, and resources needed for proper execution.

In other embodiments, the scheduling list 216 can be implemented as a delimited flat file in which a task identifier, such as, for example, task location, or pointer, is listed for each task scheduled to be executed in the order in which the task is to be executed. In still other embodiments, the scheduling list 216 can be implemented as a data array in system memory 154.

Because some tasks may rely on outputs (e.g., data, results, etc.) from other tasks (e.g. the task dependencies) the scheduler 214 can assign the dependency tasks early time slots in order to ensure that outputs from the dependency tasks are available to the other tasks. In some embodiments, the scheduler 214 can be configured to actively monitor the progress of each task to confirm successful completion of the task. This can be especially useful in cases where the task is a dependency task upon whose output one or more other later scheduled task depend. Additionally, the scheduler 214 can be configured to reschedule tasks that depend on output from an earlier task that has not yet completed successfully. In cases where the scheduler 214 needs to reschedule a task, the scheduler 214 can request an updated risk assessment from the risk assessor 210 for the remaining tasks.

A task launcher 218 of the cognitive scheduling engine 200, implemented, for example, as software executed by the processor 102, accesses the scheduling list 216 and instructs the processor 102 to execute each of the plurality of tasks in chronological order based on the assigned time slot. In embodiments in which the processor 102 includes multiple processors, multiple processing cores, and/or a sufficient number of threads, the scheduler 214 can schedule more that one task in the same time slot. Thus, the task launcher 218 can instruct the processor 102 to execute multiple tasks simultaneously. In other embodiments, the task launcher 218 can be configured to monitor available system resources, and as sufficient resources are freed up by completion of a previous task, the task launcher 218 can instruct the processor 102 to proceed with execution of the next task in the scheduling list 216. The task launcher 218 can be configured to track where dependency tasks have completed successfully before instructing the processor 102 proceed with executing the next task.

Upon completion of each scheduled task, whether successfully or not, the job launcher 218, in some embodiments, can generate a log 220 that includes information for each task regarding, for example, completion status (e.g., success, fail, errors, warnings, etc.), resource usage, start time, and processing duration. In cases where the task issued messages relating to errors, warnings or comments during execution, the issued messages can be included in the log 220 as well. The log 220 can be embodied in a database or delimited flat file stored in, for example, the first storage 134 and/or the second storage 136 of the physical server 100. Additionally, the task launcher 218 can report to the scheduler 214 whether a task completed successfully or failed.

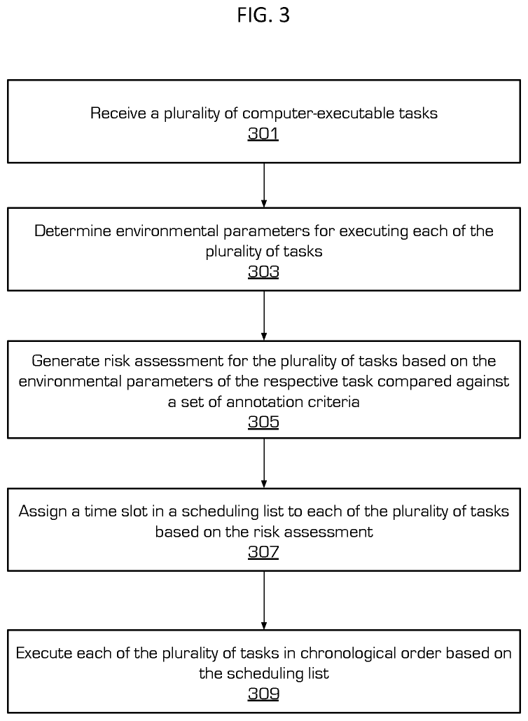

Turning to FIG. 3, a process executed by an embodiment is shown. In an embodiment, the process shown in FIG. 3 is embodied as computer executable program code stored in, for example, first storage 134, second storage 136, ROM 104 and/or system memory 154 of the physical server 100 shown in FIG. 1. In an embodiment the computer executable program code embodying the process shown in FIG. 3 can be stored in the cloud and accessed by way of a network adapter 110 of the physical server 100 (see: FIG. 1). The computer executable program code embodying the process shown in FIG. 3 can be configured to instruct a processor, such as, for example, a processor 102 shown in FIG. 1, a graphic processing unit (GPU), field programmable gate array (FPGA), and/or microcontroller, to perform the process blocks described below. In an embodiment, an FPGA can be configured to embody the process shown in FIG. 3 by way of instruction sets encoded into the gate array structure.

The cognitive scheduling process begins at block 301 by receiving a plurality of computer executable tasks. For example, tasks can be received by the cognitive scheduling process at block 301 from various sources such as a local area network, a wide area network, and/or a public cloud network (e.g., the Internet) via a network adapter 110. Additionally, the cognitive scheduling process at block 301 can receive tasks by way of user input via a user interface 114, shown in FIG. 1, that can include a graphical user interface (GUI) presented to the user on a display, such as, for example, the display device 174 shown in FIG. 1. In some embodiments, the user can interact with the GUI using a keyboard 164, mouse 166 (or other pointing device), and/or other input devices 168 as shown in FIG. 1, to select tasks for scheduling by the cognitive scheduling process.

At block 303, the process determines environmental parameters for executing each of the plurality of tasks. These environmental parameters relate to the requirements of each individual task needed to properly execute, and successfully complete the task. For example, a task may have a required minimum available memory. In another example, the task may require a connection to the Internet in order to download data (e.g., when updating applications) or upload data (e.g., when performing off-site backups). In yet another example, the task may require a minimum amount of processing resources (e.g., cores, threads, etc.) such as, for example, when performing processor intensive data processing like computer-generated image (CGI) rendering or complex simulations and modelling. In still another example, the task may require data (inputs) generated as outputs by other applications, or tasks. These other applications and tasks form a task's dependencies.

Additionally, the environmental parameters can include a priority value indicating the criticality of the task being completed successfully. For example, a virus scan or backup may have a high criticality, meaning that it is very important that these tasks be completed successfully at each scheduled execution, while an application update may be considered to have a lower criticality.

At block 305, the process generates a risk assessment for the plurality of tasks based on the environmental parameters of the respective tasks compared against a set of annotation criteria. The annotation criteria are a set of properties that outline the constraints under which the tasks are to be run. For example, certain tasks may need to be completed by a certain time each night, as may be the case at a financial institution that may need to reconcile numerous daily transactions and report results to regulatory agencies by a set deadline. Another example of an annotation criteria can be the system specifications, e.g., amount of memory available, processing power (cores, threads, etc.), free storage capacity, network bandwidth, installed programs, etc. At block 305, the risk assessment can be calculated using a Bayesian algorithm (for example, the algorithm shown in Eq. 1 and Eq. 2) to evaluate the environmental parameters and annotation criteria of a task to minimize the risk of downtime for critical tasks.

The process continues to block 307, where a time slot is assigned in a scheduling list to each of the plurality of tasks based on the risk assessment. The cognitive scheduling process proceeds to block 309, where the processor 102, for example, is instructed to execute each of the plurality of tasks in chronological order based on the scheduling list.

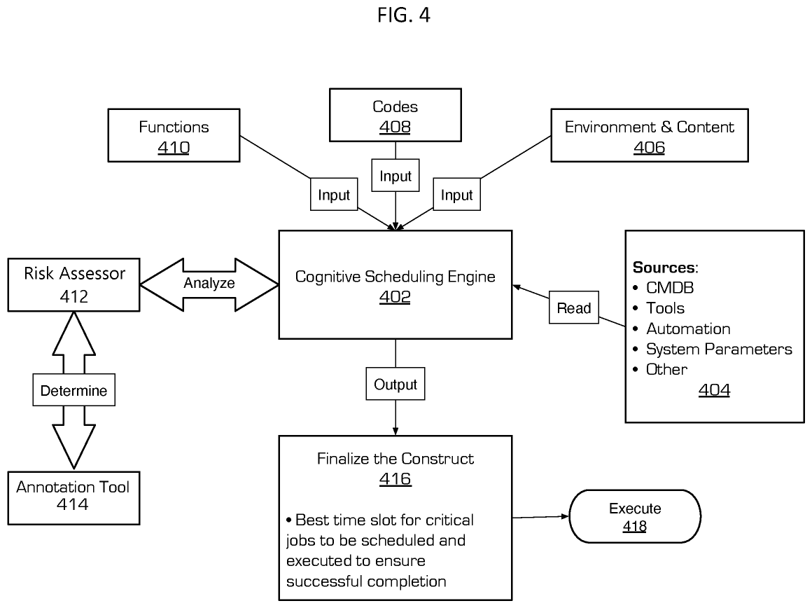

Turning to FIG. 4, another embodiment is shown representing the operation of the cognitive scheduling engine 402. The cognitive scheduling engine 402 reads task scheduling information from a plurality of sources 404, such as, for example, CMDB, tools, automation, system parameters, etc. The task scheduling information can include existing jobs, prescheduled activities, etc. Additionally, the cognitive scheduling engine 402 receives, as inputs, data from environment and content 406 (e.g., parameters of the systems executing the scheduled tasks), codes 408 and functions 410 of the current activities of the scheduled jobs (e.g., tasks), such as for example, resources required to execute different activities which will impact a new job to be scheduled, and their boundaries, e.g., parameter settings used to execute tasks of a scheduled job. Using the received task scheduling information from the sources 404 and the inputs from the environment and content 406, the codes 408 and the functions 410, the cognitive scheduling engine 402 analyzes a risk assessment 412.

The risk assessment is performed using Bayes' Theorem, as represented by, for example, Eq. 1 and Eq. 2 based on characteristic criteria to ensure the most critical functions are managed at the lowest risk. In other words, the cognitive scheduling engine applies the risk assessment in order to properly schedule the tasks such that the most critical tasks are able to be executed and completed within the preset constraints (e.g., characteristic criteria) with the least risk of failure. Bayes' Theorem describes the probability of a schedule being successfully completed, based on existing information and knowledge of conditions that might be related to the schedules. The risk assessment 412 includes characteristic criteria provided by an annotation tool 414. The criteria can include tasks, algorithms, checksums, rework ability (e.g. to re-execute the job or send an alert on the job), conflicts, errors, etc.

The cognitive scheduling engine 402 receives the results of the risk assessment and determines a scheduling for the tasks that ensures successful completion of at least the critical tasks. The finalized schedule construct 416 reflects the best timeslots for the tasks, especially the critical tasks, such that the tasks can be completed within the allotted time. The finalized schedule construct 416 can include triggering other activities in a multi-cloud environment, e.g. to execute or schedule a job to be executed in a different on-premise cloud, private cloud, or public cloud environment. At the scheduled time each task is executed in the multi-cloud environment 418 in accordance with the finalized schedule construct 416.

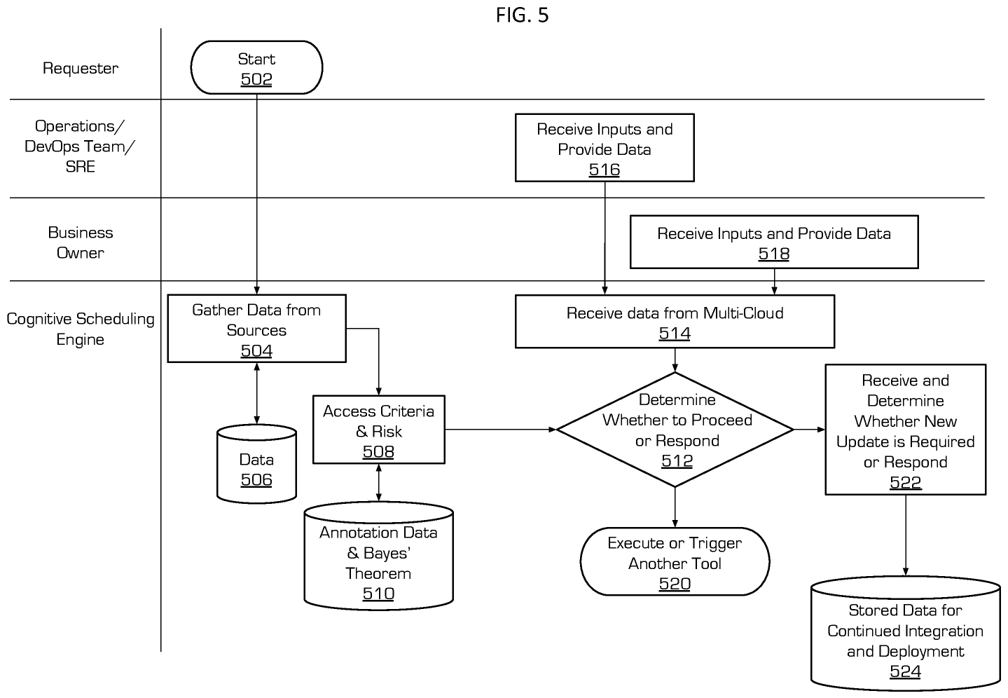

Turning to the embodiment shown in FIG. 5, the cognitive scheduling method begins with a requester issuing a start command at block 502. The requester can be any authorized user of the system that is initiating a request that a particular task or job be scheduled for execution. Once the request has been made by way of block 502, the cognitive scheduling engine, such as, for example, cognitive scheduling engine 200 or 402, gathers data at block 504 from various source, such as a data store 506, for example. The gathered data is used at block 508 to access criteria and develop risk assessments based on annotation data and algorithms implementing Bayes' Theorem received from a data store 510.

Additionally, data is received from multi-cloud environments at block 514. The data received at block 514 can include inputs and data provided at block 516 by Operations, Developer Operations and/or site reliability engineering teams. Also, a business owner can provide inputs and data at block 518, which is then provided to block 514. The data acquisition executed by blocks 514 through 518 can be configured to occur concurrently, simultaneously or in series with the data gathering performed at block 504.

Using the received data from block 514, and criteria and the risk assessment from block 508, the cognitive scheduling engine determines, at block 512, whether to proceed to block 522 and schedule the task, or whether proceed to block 520 to execute another tool. At block 522 the cognitive scheduling engine determines whether the scheduling list needs to be updated to include the requested task. For example, if the requested task is a duplicate of a task already scheduled to execute, then the cognitive scheduling engine may determine that an update is not needed. In the case an updated scheduling list is generated, block 522 stores the updated scheduling list in a data store 524.

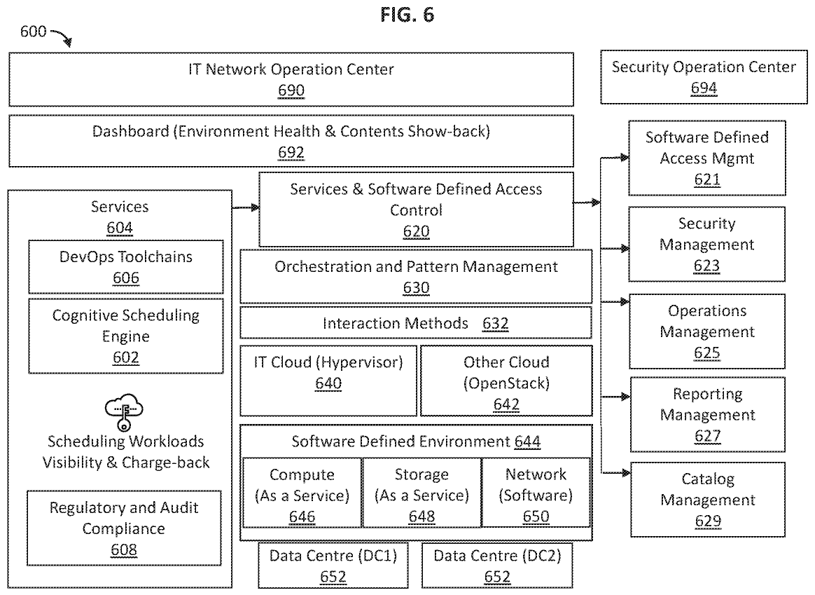

FIG. 6 illustrates an service environment 600 in which an embodiment of a cognitive scheduling engine 602 is implemented. In the illustrated service environment 600, the cognitive scheduling engine 602 can be configured as one of a plurality of information technologies (IT) services 604. The IT services can additionally include Developer Operations (DevOps) toolchains 606 and regulatory and audit compliance services 608. In some embodiments, the cognitive scheduling engine 602 is in communication with the plurality of other IT services 604. For example, the cognitive scheduling engine 602 can communicate with the regulatory and audit compliance services 608 to ensure that scheduled tasks required for compliance purposes are executed in a manner that satisfies the compliance requirements.

The cognitive scheduling engine 602, as well as the plurality of other IT services 604 can be made available to service subscribers by way of services and software defined access control 620. The services and software defined access control 620 can provide management services including software defined access management 621, security management 623, operations management 625, reporting management 627 and catalog management 629. The software defined access management 621 can further include advertising services. The operations management can include configuration management database and service desk tools. Chargeback services can be incorporated into reporting management 627, as well. The catalog management 629 can further provide application programming interfaces (APIs) and artifacts, and implement a library management system.

Additionally, the service environment 600 includes orchestration and pattern management 630 configured to provide automated workflow optimization for the various services, e.g., containerization and virtualization services, offered to subscribers. Interaction methods 632, including catalog, containers and APIs can be provided by the service environment 600 to facilitate access to various Cloud computing environments, such as, for example, a Hypervisor IT Cloud 640 or OpenStack-based Cloud 642. The Cloud computing environments can be configured to provide software defined environments 644, such as virtual servers, for example, that provide compute as a service (CaaS) 646, storage as a service (SaaS) 648, and network as a service (NaaS). Additionally, access to data centers 652 can be provided to subscribers by way of the service environment 600.

Additionally, the service environment 600 can include an IT network operations center 690 providing oversight and control of the service environment 600 through the use of, for example, a dashboard application 692. A security operation center 694 can be implemented, as well, to monitor cybersecurity issues, etc. impacting the service environment 600.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

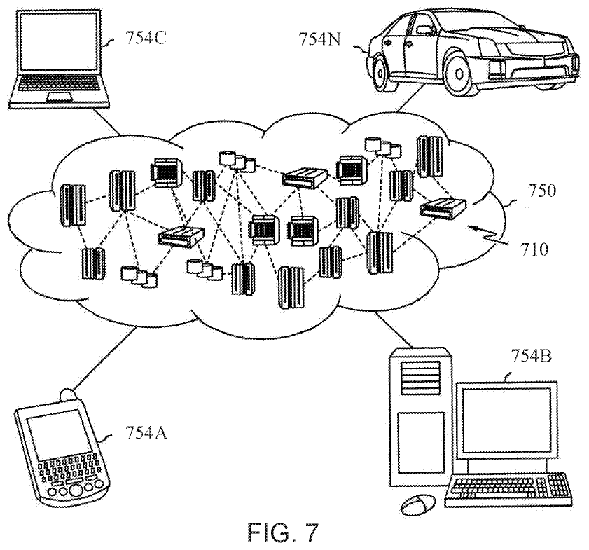

Referring now to FIG. 7, illustrative cloud computing environment 750 is depicted. As shown, cloud computing environment 750 includes one or more cloud computing nodes 710 with which local computing devices used by cloud consumers, such as, for example, personal digital assistant (PDA) or cellular telephone 754A, desktop computer 754B, laptop computer 754C, and/or automobile computer system 754N may communicate. Nodes 710 may communicate with one another. They may be grouped (not shown) physically or virtually, in one or more networks, such as Private, Community, Public, or Hybrid clouds as described hereinabove, or a combination thereof. This allows cloud computing environment 750 to offer infrastructure, platforms and/or software as services for which a cloud consumer does not need to maintain resources on a local computing device. It is understood that the types of computing devices 754A-N shown in FIG. 7 are intended to be illustrative only and that computing nodes 710 and cloud computing environment 750 can communicate with any type of computerized device over any type of network and/or network addressable connection (e.g., using a web browser).

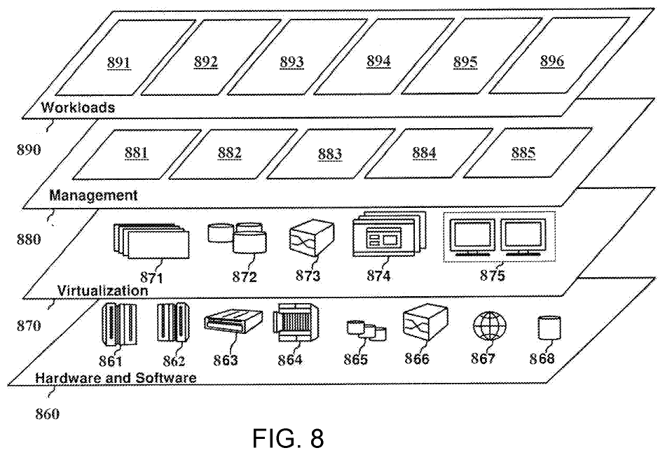

Referring now to FIG. 8, a set of functional abstraction layers provided by cloud computing environment 750 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 860 includes hardware and software components. Examples of hardware components include: mainframes 861; RISC (Reduced Instruction Set Computer) architecture based servers 862; servers 863; blade servers 864; storage devices 865; and networks and networking components 866. In some embodiments, software components include network application server software 867 and database software 868.

Virtualization layer 870 provides an abstraction layer from which the following examples of virtual entities may be provided: virtual servers 871; virtual storage 872; virtual networks 873, including virtual private networks; virtual applications and operating systems 874; and virtual clients 875. Embodiments of the present invention can implement cognitive scheduling across distributed environments that can include the virtual servers 871, the virtual applications and operating systems 874, virtual storage 872, etc. provided by the virtualization layer 870 of the cloud computing environment 750.

In one example, management layer 880 may provide the functions described below. Resource provisioning 881 provides dynamic procurement of computing resources and other resources that are utilized to perform tasks within the cloud computing environment. Metering and Pricing 882 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 883 provides access to the cloud computing environment for consumers and system administrators. Service level management 884 provides cloud computing resource allocation and management such that required service levels are met. Service Level Agreement (SLA) planning and fulfillment 885 provide pre-arrangement for, and procurement of, cloud computing resources for which a future requirement is anticipated in accordance with an SLA.

Workloads layer 890 provides examples of functionality for which the cloud computing environment may be utilized. Examples of workloads and functions which may be provided from this layer include: mapping and navigation 891; software development and lifecycle management 892; virtual classroom education delivery 893; data analytics processing 894; transaction processing 895; and cognitive scheduling 896, such as the cognitive scheduler 200 (FIG. 2), for example.

As employed herein, the terms “hardware processor subsystem”, “hardware processor” or “processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present disclosure.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a system and method of a cognitive scheduling engine (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer-implemented cognitive scheduling method, comprising:
receiving a plurality of computer executable tasks;
determining environmental parameters for executing each of the plurality of computer executable tasks;
generating a risk assessment for the plurality of computer executable tasks based on the environmental parameters of the respective computer executable tasks compared against a set of annotation criteria;
assigning a time slot in a scheduling list to each of the plurality of computer executable tasks based on the risk assessment; and
executing each of the plurality of computer executable tasks in chronological order based on the scheduling list.

2. The computer implemented method of claim 1, wherein the risk assessment is generated based on a Bayesian algorithm.

3. The computer implemented method of claim 2, wherein the Bayesian algorithm includes:
$${P}_{( h \vert d )} = \frac{{P}_{( d \vert h )} \times {P}_{( h )}}{{P}_{( d )}} ,$$
where P_{(h|d)} is a posterior probability of hypothesis h being true given the data d, P_{(d|h)} is a likelihood, P₍ₕ₎ is a class prior probability, and P_{(d)} is a predictor prior probability.

4. The computer implemented method of claim 1, wherein the set of annotation criteria are one or more parameters under which the plurality of computer executable tasks are to be executed.

5. The computer implemented method of claim 4, wherein the set of annotation criteria includes a completion deadline by which the plurality of computer executable tasks must be completed.

6. The computer implemented method of claim 1, wherein the environmental parameters include respective resource requirements for each of the plurality of computer executable tasks.

7. The computer implemented method of claim 1, further comprising generating a unique checksum for each of the tasks based on the risk assessment of the plurality of computer executable tasks.

8. A cognitive scheduling system, comprising:
a network interface configured to receive a plurality of computer executable tasks over a network;
a storage device configured to store the plurality of computer executable tasks, a set of annotation criteria and a scheduling list; and
a processor configured to:
determine environmental parameters for executing each of the plurality of computer executable tasks stored in the storage device;
generate a risk assessment for the plurality of computer executable tasks based on the environmental parameters of the respective computer executable tasks compared against the set of annotation criteria;
assign a time slot in the scheduling list to each of the plurality of computer executable tasks based on the risk assessment; and
execute each of the plurality of computer executable tasks in chronological order based on the scheduling list.

9. The cognitive scheduling system of claim 8, wherein the risk assessment is generated based on a Bayesian algorithm.

10. The cognitive scheduling system of claim 9, wherein the Bayesian algorithm includes:
$${P}_{( h \vert d )} = \frac{{P}_{( d \vert h )} \times {P}_{( h )}}{{P}_{( d )}} ,$$
where P_{(h|d)} is a posterior probability of hypothesis h being true given the data d, P_{(d|h)} is a likelihood, P₍ₕ₎ is a class prior probability, and P_{(d)} is a predictor prior probability.

11. The cognitive scheduling system of claim 8, wherein the set of annotation criteria are one or more parameters under which the plurality of computer executable tasks are to be executed.

12. The cognitive scheduling system of claim 11, wherein the set of annotation criteria includes a completion deadline by which the plurality of computer executable tasks must be completed.

13. The cognitive scheduling system of claim 8, wherein the environmental parameters include respective resource requirements for each of the plurality of computer executable tasks.

14. The cognitive scheduling system of claim 8, wherein the processor is further configured to generate a unique checksum for each of the computer executable tasks based on the risk assessment of the plurality of computer executable tasks.

15. A computer readable storage medium comprising a computer-readable program for implementing cognitive scheduling, wherein the computer-readable program, when executed on a computer, causes the computer to perform the steps of:
receiving a plurality of computer executable tasks;
determining environmental parameters for executing each of the plurality of computer executable tasks;
generating a risk assessment for the plurality of computer executable tasks based on the environmental parameters of the respective computer executable tasks compared against a set of annotation criteria;
assigning a time slot in a scheduling list to each of the plurality of computer executable tasks based on the risk assessment; and
executing each of the plurality of computer executable tasks in chronological order based on the scheduling list.

16. The computer readable storage medium of claim 15, wherein the risk assessment is generated based on a Bayesian algorithm.

17. The computer readable storage medium of claim 16, wherein the Bayesian algorithm includes:
$${P}_{( h \vert d )} = \frac{{P}_{( d \vert h )} \times {P}_{( h )}}{{P}_{( d )}} ,$$
where P_{(h|d)} is a posterior probability of hypothesis h being true given the data d, P_{(d|h)} is a likelihood, P₍ₕ₎ is a class prior probability, and P_{(d)} is a predictor prior probability.

18. The computer readable storage medium of claim 15, wherein the set of annotation criteria are one or more parameters under which the plurality of computer executable tasks are to be executed.

19. The computer readable storage medium of claim 18, wherein the set of annotation criteria includes a completion deadline by which the plurality of computer executable tasks must be completed.

20. The computer readable storage medium of claim 15, wherein the environmental parameters include respective resource requirements for each of the plurality of computer executable tasks.
